(19) United States
(12) Patent Application Publication
(10) Pub. No.: US 2016/0074273 A1
(43) Pub. Date: Mar. 17, 2016

(54) TOOLKIT FOR MASSAGE AND MUSCLE RELEASE

(71) Applicant: RAD INNOVATION LLC, Denver, CO (US)

(72) Inventor: Michael Mallory, Evergreen, CO (US)

(21) Appl. No.: 14/487,920

(22) Filed: Sep. 16, 2014

(51) Int. Cl. A61H 15/00

(52) U.S. Cl. CPC A61H 15/00; A61H 2201/1671

(57) ABSTRACT

A massage toolkit includes one or more spherical balls, a massage device and a block. The massage device has the shape of a pair of truncated spherical balls of a first diameter, separated by a substantially cylindrical section having a smaller, second diameter. The distance separating the truncated spherical balls is designed to accommodate a skeletal portion of a user while the truncated spherical balls massage muscles positioned close to and on both sides of the skeletal portion. The block includes two or more holes sized to hold the balls and the massage device during transport, and to hold the one or more balls and the massage device when used together with the block for self-massage. The block further includes one or more semi-spherical indentations for holding the massage device in a stationary position when used together with the block for self-massage

### BACKGROUND

The present invention relates to exercise equipment, and more specifically, to a set of tools allowing a user to self-apply massage to areas of the spine and other areas of the body, such as legs and arms.

Self-myofascial release (SMR) techniques are commonly used by athletes and physical therapists to aid in recovery of muscles that are prone to being overactive. Fascia is the collagenous portion of the connective tissue in the muscle that provides support, protection, and shape. The fascia can become restricted due to overuse, trauma, and inactivity. Consequently, inflammation may occur and if it becomes bad enough the connective tissue can thicken, which may result in pain irritation, and additional inflammation.

There are several known tissue massagers or manipulators that use a pair of lobes or balls that are mounted along a shaft that supports the lobes or balls. The lobed or ball shaped sections are typically used to knead tight muscles, which causes them to release, and thus relieve tension and tension related issues experienced by the user.

A problem associated with known devices is that the spacing of the lobes or balls is much wider than the spinous processes, and thus result in uneven massaging of the erector spinae muscles, which are the muscles near the spinous processes. Additionally, due to the curvature and flexibility of the ribs, a large spacing will result in contact of the shaft with the tissue directly over the spinal processes. Still further, widely spaced spheres or rounded areas on massaging devices will be entirely ineffective at kneading or massaging of muscles around large bones such as the femur, or the humerus.

Accordingly, there is a need for an improved SMR techniques and devices for massaging the muscles that are positioned close to skeletal areas such as the spine and the femur. There is also a need for improved ways to store and transport such therapeutic devices in a convenient way.

### SUMMARY

According to one embodiment of the present invention, a massage toolkit is provided. The massage toolkit has one or more spherical balls, a massage device and a block. The massage device has the shape of a pair of truncated spherical balls of a first diameter, separated by a substantially cylindrical section having a smaller, second diameter. The distance separating the truncated spherical balls is designed to accommodate a skeletal portion of a user while the truncated spherical balls massage muscles positioned close to and on both sides of the skeletal portion. The block includes two or more holes sized to hold the balls and the massage device during transport, and to hold the one or more balls and the massage device when used together with the block for self-massage. The block further includes one or more semi-spherical indentations for holding the massage device in a stationary position when used together with the block for self-massage.

Various embodiments can include one or more of the following features. The two or more holes and the one or more indentations can be placed on different sides of the block. The block can be manufactured from Ethylene Vinyl Acetate foam or cork. The block can have a hardness in the range of approximately 45-55 durometers on the Shore D scale. The two or more holes can have different sizes to accommodate balls of different sizes.

The balls can have a hardness in the range of approximately 25-55 durometers on the Shore D scale. The balls can have a diameter in the range of approximately 40-63 mm.

The massage device can be molded as a single piece. The truncated spherical balls of the massage device can be made from silicone and have a hardness in the range of approximately 30-50 durometers. The truncated spherical balls of the massage device can have a diameter in the range of approximately 40-63 mm. The distance between the centers of the truncated spherical balls of the massage device is approximately in the range of 60-70 mm. The diameter of the cylindrical portion separating the truncated spherical balls of the massage device can be approximately in the range of 20-30 mm. The balls can be made from silicone, rubber, or styrene-butadiene. The massage device can be made from silicone, rubber, or styrene-butadiene.

The details of one or more embodiments of the invention are set forth in the accompanying drawings and the description below. Other features and advantages of the invention will be apparent from the description and drawings, and from the claims.

### BRIEF DESCRIPTION OF THE SEVERAL VIEWS OF THE DRAWINGS

FIG. 1 is a perspective view of the massage device in accordance with one embodiment of the invention while in use to knead the muscles along the spine.

FIG. 2 is a partial cross-section of the massage device in accordance with one embodiment of the invention.

FIG. 3 shows a block (300) in accordance with one embodiment.

FIG. 4 shows a massage device in accordance with another embodiment of the invention.

Like reference symbols in the various drawings indicate like elements.

### DETAILED DESCRIPTION

The various embodiments of the invention provide a kit of massage tools that can be used in various combinations for SMR. The massage tools are specifically designed for human anatomy, such that muscle tension can be released and muscles can be pumped of lymph, while releasing collagenous restrictions and avoiding unhealthy stresses on the muscles. In one embodiment, the massage kit includes one or more balls, a massage device having two truncated balls mounted along a rigid shaft and separated by a disk, and a block for storage of the balls and massage device during transport and for enhancing the usability of the massage device and the balls. In another embodiment, there is no rigid shaft or disk, but the two truncated balls are molded as a single piece having essentially the same shape. Each of these massage tools and their interactions will now be described by way of example and with reference to the drawings. However, as the skilled reader realizes, this is merely one embodiment and many variations that fall within the scope of the appended claims can be contemplated by those having ordinary skill in the art.

### Balls

It is common practice to use various types of balls for muscle release. One common example is to use a tennis ball for SMR. The basic idea of tennis ball massage, or any massage with any kind of ball, is simply to trap the ball between the body and something else: usually the floor, sometimes a wall, another body part, etc. The goal is to achieve a “release” by applying just the right amount of pressure: enough to do some good, but not enough to irritate the knot. Ball massage is usually the most effective in the muscles of the back and the hips.

A drawback with using tennis balls is that they are typically either too hard or too soft, as they are designed for tennis and not for SMR. Therefore, in accordance with one embodiment of the invention, the massage kit includes one or more balls that have a carefully chosen hardness that is especially suited for firm muscle release, while at the same time not being too stiff for sensitive areas, such as the neck.

In one embodiment, the balls are made of silicone, but other materials may also be used, such as natural or recycled rubber, or styrene-butadiene. The hardness of the balls is typically in the range of about 25-55 D (durometers) on the Shore D scale.

Typically two or more balls are provided, which may have different diameters and/or hardness, such that the balls can be used on various parts of the body, for example, the cervical spine, feet, hands, etc. The diameter of the balls is typically in the range of approximately 40-63 mm. In one embodiment, the balls have a matte finish so as to improve the friction between the ball and the underlying surface and user, respectively, and prevent slippage. In some embodiments the balls may have small ridges or bumps on the surface, which may further improve the friction between the ball and the underlying surface and user. Balls of different density may also have different colors, such that a user knows which ball is harder among a selection of several balls.

As will be described in further detail below, in one embodiment the balls have sizes that match holes in the block, such that the balls can be easily transported together with the block.

### Massage Device

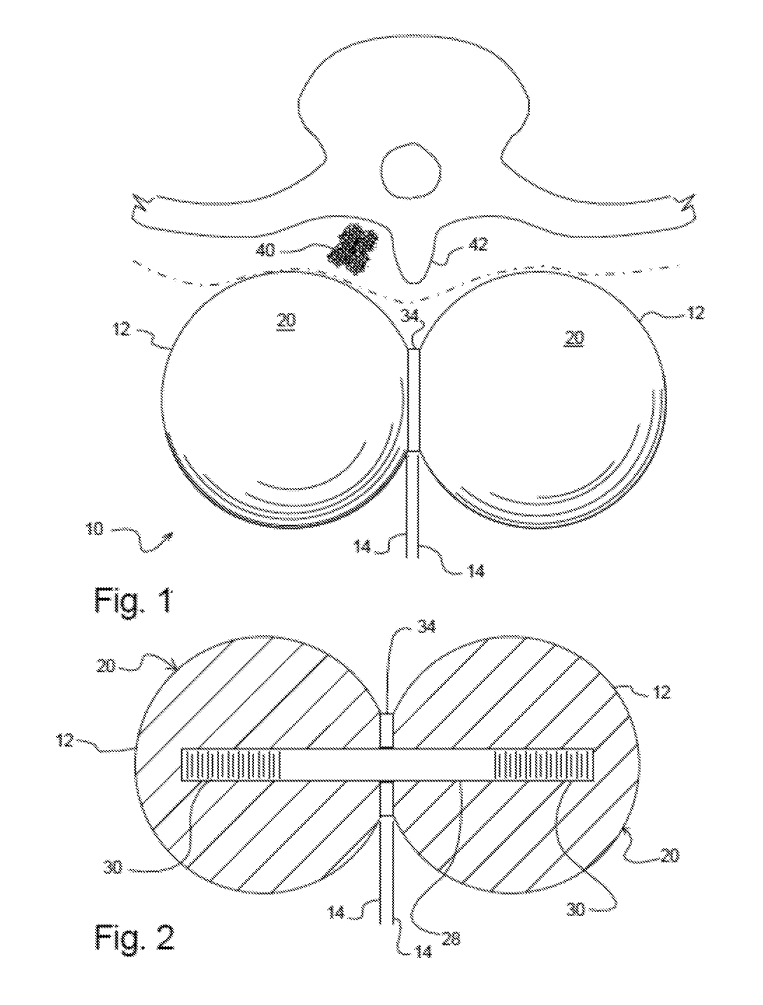

The massage device will now be described in further detail with reference to FIGS. 1 and 2, which show a perspective view and partial cross-section view, respectively, of a massage device (10) in accordance with one embodiment.

The embodiment of the massage device (10) illustrated in FIGS. 1 and 2 includes a pair of truncated spherical balls (12) that have been truncated along a plane (14), such that a spherical cap (not shown) has been removed from each truncated spherical ball (12).

Similar to what was described above, in one embodiment, the truncated spherical balls (12) are made of silicone, but other materials may also be used, such as natural or recycled rubber, or styrene-butadiene. The diameter of each of the truncated spherical balls (12) is typically in the range of approximately 40-63 mm. The hardness of the truncated spherical balls (12) is typically in the range of about 25-55 D on the Shore D scale. In one embodiment, the massage device (10) has a matte finish so as to improve the friction between the massage device and the underlying surface and user, respectively, and to prevent slippage.

FIG. 2 also shows a rigid joining shaft (28), which in the illustrated embodiment is made from steel and includes a threaded section (30) at each end. The joining shaft (28) is used to join the two truncated spherical balls (12) with the truncated end of each ball (12) facing one another. As can be seen in FIG. 2, the massage device (10) further includes a resilient disk (34) that works as a spacer to separate the truncated ends of the two truncated spherical balls (12) from one another. The resilient disk (34) has a diameter that is substantially the same as the diameter of the truncated ends of the balls (12). The resilient disk (34) has a resiliency that provides a degree of flexibility to the assembly, and positions the surfaces of the truncated spherical balls (12) such that they bear against the spinalis muscles (40) on opposite sides of the spinous processes (42).

As can further be seen in FIG. 2, the rigid joining shaft (28) extends into each of the balls (12) and has a length that is longer than twice the diameter of the truncated spherical balls (12), so that the joining shaft (28) extends through each of the centers of the balls (12) when the joining shaft joins the balls (12) with the disk (34) separating the balls (12).

It should be noted that there are also other embodiments of the massage device (10) in which no rigid joining shaft (28) or resilient disk (34) are provided. For example, FIG. 4 shows a massage device (40) that has essentially the same shape as the massage device and functionality as the massage device (10) described above with respect to FIG. 2. However in the embodiment illustrated in FIG. 4, the entire massage device (40) is molded as a single piece, which simplifies manufacturing and reduces the risk of damage to the massage device (40). Also here, the massage device (40) can have a matte finish so as to improve the friction between the massage device (40) and the underlying surface and user, respectively, and prevent slippage.

### Block

The third part of the massage kit is a block, which serves both as a device for storage of the balls and the massage device (10) described above, and as an assisting device for leveraging the use of the balls and the massage device (10). Often a user needs a raised platform to perform SMR on areas that are difficult to work with on the floor. For instance, if a user would like to work on her adductors (inner leg/groin), the user would place the balls or the massage device (10) in holes that are provided on top of the block and roll the leg on top of the balls or massage device (10). The same arrangement can be used to allow the user to massage hands free, for example, the suboccipitals (neck muscles just below the base of the skull).

In some embodiments, as will be described in further detail below, the block contains indentations on the side of the block, which can be used for reaching muscles like the subscapularis. When used for this purpose, the block is placed on the ground with the side opposite the indentations against the ground. The user places the massage device (10) in the indentations so that the massage device (10) does not roll, and the user can then access the muscles in and around her armpit (e.g., the pectoralis major muscle, the subscapularis muscle, etc.).

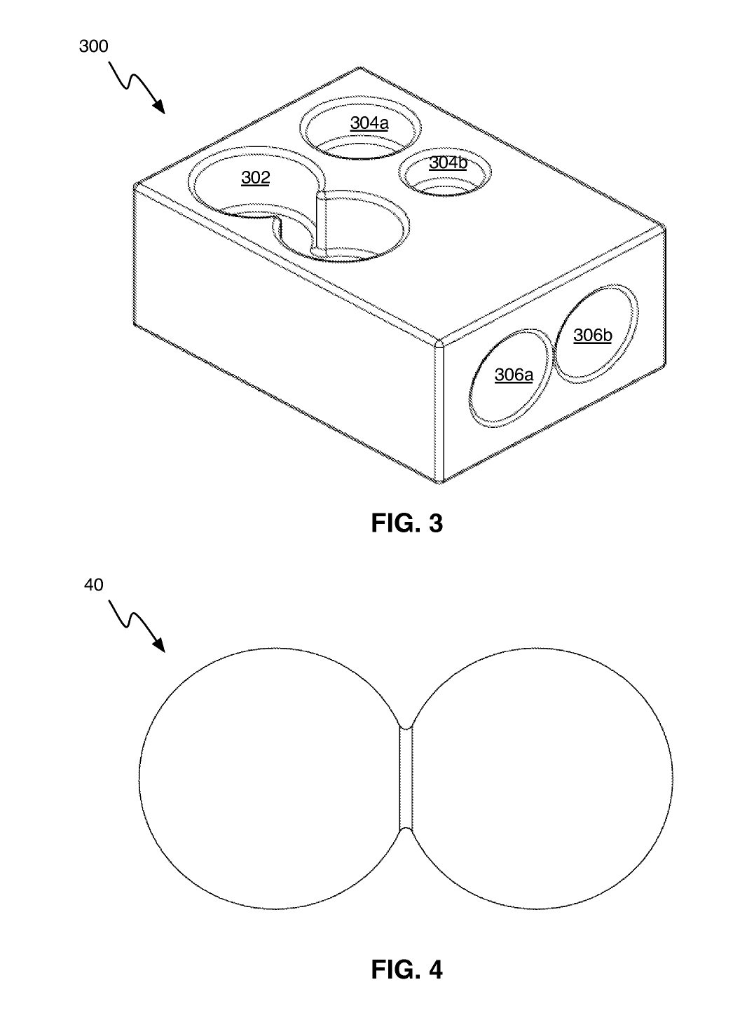

FIG. 3 shows a block (300) in accordance with one embodiment. The top surface of the block (300) has a set of holes (302) sized to accommodate the massage device (10) described above, both for SMR purposes, and for storage and/or transport. A second set of holes (304a, 304b) is sized to accommodate the balls described above for storage and/or transport.

The embodiment of the block (300) illustrated in FIG. 3, further contains two semi-spherical indentations (306a, 306b) on a side surface that are adapted to hold the massage device (10) when used for SMR purposes, as described above, to prevent the massage device (10) from rolling off the block when in use. It should be noted that the number of holes and indentations shown in the drawings are merely one exemplary embodiment. Other embodiments may have more or fewer holes and/or indentations, and the holes and/or indentations can be located on different surfaces of the block (300) depending on the number and size of components in the kit and how they are used with and/or stored in the block (300).

In one embodiment the block (300) is made out of EVA Foam with a hardness approximately in the range of 45-55 D on the Shore D Hardness scale. In a different embodiment, the block can be made from cork. Of course, as the skilled person realizes, the block (300) does not have to be used in conjunction with the massage device (10) and/or the balls. The block (300) can also be used as a stand-alone standard yoga or gymnastics prop.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A massage toolkit, comprising:
one or more spherical balls;
a massage device having the shape of a pair of truncated spherical balls of a first diameter, the spherical balls being separated by a substantially cylindrical section having a second diameter, wherein the second diameter is smaller than the first diameter, and wherein a distance separating the truncated spherical balls is designed to accommodate a skeletal portion of a user while the truncated spherical balls massage muscles positioned close to and on both sides of the skeletal portion; and
a block comprising:
two or more holes sized to hold the one or more balls and the massage device during transport, and to hold the one or more balls and the massage device when used together with the block for self-massage; and
one or more semi-spherical indentations for holding the massage device in a stationary position when used together with the block for self-massage.

2. The massage toolkit of claim 1, wherein the two or more holes and the one or more indentations are placed on different sides of the block.

3. The massage toolkit of claim 1, wherein the block is manufactured from one of: Ethylene Vinyl Acetate foam and cork.

4. The massage toolkit of claim 1, wherein the block has a hardness in the range of approximately 45-55 durometers on the Shore D scale.

5. The massage toolkit of claim 1, wherein the two or more holes have different sizes to accommodate balls of different sizes.

6. The massage toolkit of claim 1, wherein the balls have a hardness in the range of approximately 25-55 durometers on the Shore D scale.

7. The massage toolkit of claim 1, wherein the balls have a diameter in the range of approximately 40-63 mm.

8. The massage toolkit of claim 1, wherein the massage device is molded as a single piece.

9. The massage toolkit of claim 1, wherein the truncated spherical balls of the massage device are made from silicone and have a hardness in the range of approximately 30-50 durometers.

10. The massage toolkit of claim 1, wherein the truncated spherical balls of the massage device have a diameter in the range of approximately 40-63 mm.

11. The massage toolkit of claim 1, wherein the distance between the centers of the truncated spherical balls of the massage device is approximately in the range of 60-70 mm.

12. The massage toolkit of claim 1, wherein the diameter of the cylindrical portion separating the truncated spherical balls of the massage device is approximately in the range of 20-30 mm.

13. The massage toolkit of claim 1, wherein the balls are made from one of: silicone, rubber, and styrene-butadiene.

14. The massage toolkit of claim 1, wherein the massage device is made from one of: silicone, rubber, and styrene-butadiene.
